(19) United States
(12) Patent Application Publication
(10) Pub. No.: US 2018/0198717 A1
(43) Pub. Date: Jul. 12, 2018

(54) A SMART FLOW CLASSIFICATION METHOD/SYSTEM FOR NETWORK AND SERVICE FUNCTION CHAINING

(71) Applicant: ZTE CORPORATION (CHINA), Shenzhen (CN)

(72) Inventors: Bhumip Khasnabish, Lexington, MA (US); Meng Wei, Nanjing (CN)

(21) Appl. No.: 15/504,975

(22) PCT Filed: Aug. 21, 2014
(86) PCT No.: PCT/CN2014/084931

§ 371 Date: Feb. 17, 2017

(51) Int. Cl. H04L 12/851; H04L 12/931

(52) U.S. Cl. CPC H04L 47/2441; H04L 49/70

(57) ABSTRACT

This patent application describes an intelligent method/system for flow classification for network and service function chaining. A chain is an ordered sequence of network/service entities. However, the method described here can be equally applied to any unordered sequence (a group) of network/service entities as well. The Network functions (NFs) can be physical or virtual or a combination of both in the chained path. The Service functions (SFs) can be physical or virtual or a combination of both in the chained path. The proposed Classifier is intelligent in the sense that it learns and adapts to the requirements of the flows (or a stream of packets), and significantly improves the pre-processing time (and overheads) for flow classification, and hence forwarding.

### FIELD OF THE INVENTION

The present invention describes an intelligent method/system for flow (a stream of packets) classification for network and service function chaining. As mentioned before, a chain is an ordered sequence of network/service entities. However, the method described here can be equally applied to any unordered sequence (a group) of network/service entities as well. The NFs (network functions) can be physical or virtual or a combination of both in the chained path. The SFs (service functions) can be physical or virtual or a combination of both in the chained path.

The Classifier that is proposed here is intelligent in the sense that it learns and adapts to the requirements of the flows, and significantly improves the pre-processing time (and overheads) for flow classification, and hence forwarding.

### BACKGROUND OF THE INVENTION

Traditional service function chaining (SFC) refers to directing a flow (or a stream of packets) through an ordered set of service functions like load balancer, firewall, address translator, service quality management, etc. without routing the flow back and forth from a distant physical service (value-added) device which causes wastage of network resources (bandwidth, processing power, space, power, etc.). Because of using virtualized SFs, and NFs operator can dynamically create and manage SF chains based on applications and services demands.

A recent IETF draft (http://datatracker.ietf.org/doc/draft-ietf-sfc-problem-statement/) discusses the issues associated with service function chaining. Another IETF document (http://datatracker.ietf.org/doc/draft-meng-sfc-broadband-usecases/) describes usages of service function chaining in different scenarios in broadband networks. However, without proper classification and pre-processing of the flows, the service function chain that a flow uses may not be as efficient as it can be.

This patent application discusses intelligent preprocessing in order to dynamically assign the SF chains to the flows based on the tags and stats associated with the incoming flows and expected (forecasted) loading conditions of the desired service functions.

The details of the requirements and sample operation of an intelligent Classifier are presented in this patent application.

### BRIEF SUMMARY OF THE INVENTION

This invention focuses on intelligent method/system for flow (a stream of packets) classification for network and service function chaining.

The Classifier is intelligent in the sense that it learns and adapts to the requirements of the flows (or a stream of packets), and significantly improves the pre-processing time (and overheads) for flow classification, and hence forwarding.

FIG. 1 shows a traditional flow (or packet stream) classifier. The incoming flows are simply categorized based on the tags associated with the flows. It may be also be possible to utilize some minor stats that may be available in the flow's header. The categorized flows are sent through a series of service functions (SFs) or through the network functions (NFs) as shown in the diagram. The tags and stats of the incoming flows are neither adjusted (nor any alternatives are defined) based on the loading and networking conditions of the SFs or NFs to which the SFF/NFF (SF Forwarder/NF Forwarder) forwards the flows. This may cause serious performance and service bottlenecks (or impairments in user experience).

FIG. 2 describes a smart (with coded intelligence) flow (or packet stream) classifier. The intelligence about health, security, loading, etc. conditions of SFFs, NFFs, SFs and NFs are gathered and stored in a database and then coded in manner that can easily utilized by the flow classifier during inspection of the tags/stats of the incoming flows and can be adjusted accordingly without impacting user/service experience. This database provides inputs directly to the flow director/classifier for dynamically adjusting the tags/stats of the incoming flows.

FIG. 3 shows smart flow classifier for network and service function group processing. The flow passes through a set of SFs and a set of NFs based on adjusted tags/stats in the flow header.

FIG. 4 shows smart flow classifier for processing of chained and clustered service and network functions. As shown in the diagram, the Red and Green flows pass through a series of SFs or a combination of SFs and NFs. Note that SF1 and SF2 carry both Red and Green flows and hence the loading condition of these two SFs are different from those of the other SFs here. As more and more flows demand processing through SF1 and SF2, the respective SFF can log the heavy usage information and pass it along to the intelligence gathering database which can encode this info for consumption by the flow classifier/director.

In other aspects, the invention provides a system and a computer program having features and advantages corresponding to those discussed above.

### BRIEF DESCRIPTION OF THE DRAWINGS

Having thus described the invention in general terms, reference is now made to the accompanying drawings, which are not necessarily drawn to scale. The accompanying drawings are included to provide a further understanding of the invention, and are incorporated in and constitute a part of this specification. The drawings illustrate disclosed embodiments and/or aspects and, together with the description, serve to explain the principles of the invention, the scope of which is determined by the claims.

In the drawings:

FIG. 1 shows a traditional flow (or packet stream) classifier. This diagram shows the traditional operation of a flow pre-processing (classification) based service and network function chaining.

FIG. 2 describes a smart (with coded intelligence) flow (or packet stream) classifier. This diagram shows how additional smartness can be incorporated in the flow classification phase of flow processing. The “Adaptive Policy Database” dynamically incorporated the knowledge about the operations of the SFs/NFs through monitoring the SFFs/NFFs and provides coded intelligence to the classifier for use in the decision making of flow classification.

FIG. 3 shows smart flow classifier for network and service function group processing. As shown in this diagram, a flow can be routed to an SF through an NFF in addition to being routed directly from an SFF.

FIG. 4 shows smart flow classifier for processing of chained and clustered service and network functions. This diagram shows a mode of operation where SFFs are receiving flows from the egress of the classifier for chaining to the SFs through both SFFs and NFFs.

### DETAILED DESCRIPTION OF THE INVENTION

The present inventions now will be described more fully hereinafter with reference to the accompanying drawings, in which some examples of the embodiments of the inventions are shown. It is to be understood that the figures and descriptions provided herein may have been simplified to illustrate elements that are relevant for a clear understanding of the present invention, while eliminating, for the purpose of clarity, other elements found in typical smart flow classification system and methods. Those of ordinary skill in the art may recognize that other elements and/or steps may be desirable and/or necessary to implement the devices, systems, and methods described herein. However, because such elements and steps are well known in the art, and because they do not facilitate a better understanding of the present invention, a discussion of such elements and steps may not be provided herein. The present disclosure is deemed to inherently include all such elements, variations, and modifications to the disclosed elements and methods that would be known to those of ordinary skill in the pertinent art. Indeed, these disclosure inventions may be embodied in many different forms and should not be construed as limited to the embodiments set forth therein; rather, these embodiments are provided by way of example so that this disclosure will satisfy applicable legal requirements. Like numbers refer to like elements throughout.

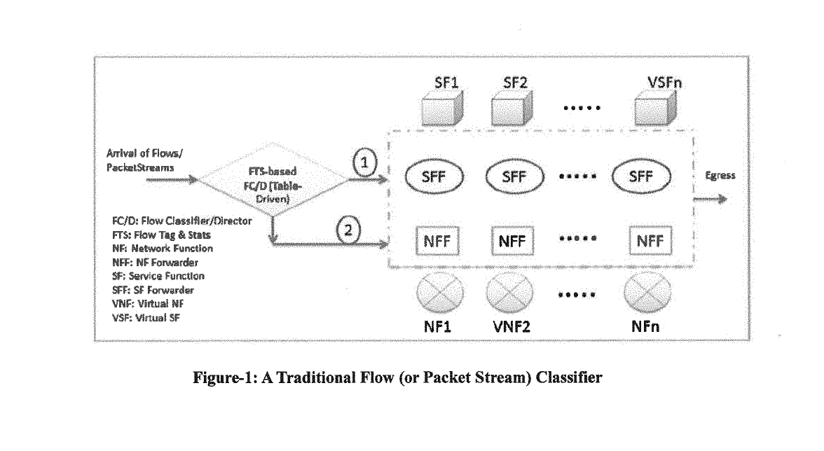

FIG. 1 shows a traditional flow (or packet stream) classifier.

As described before, the traditional flow (or packet stream) classifier categorizes the incoming flows based on the tags associated with the flows. It may be also be possible to utilize some minor stats that may be available in the flow's header. The categorized flows are sent through a series of service functions (SFs) or through the network functions (NFs) via the SFF/NFF. Note that both SF/SFF and NF/NFF can be physical or virtual or a combination of both in the path of the service chain. The classifier usually does not have any knowledge of the loading or other conditions of any of the forwarders (SFF or NFF) which may cause serious performance and service bottlenecks or impairments in user experience.

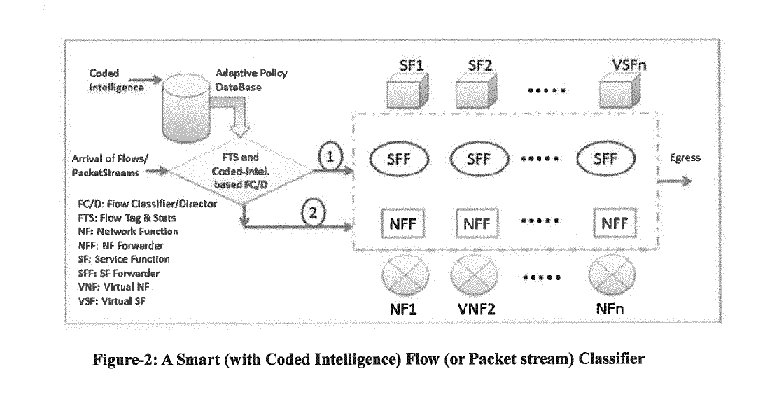

FIG. 2 describes a smart (with coded intelligence) flow (or packet stream) classifier.

As mentioned before, the Coded intelligence is derived from monitoring (health, loading, security, etc. conditions) the SFFs and NFFs. The following is one possibility for defining the granularity of monitoring of the conditions.

SFF (or NFF) Health condition={frail, modest, steady}

SFF (or NFF) Loading condition={low, medium, high}

SFF (or NFF) Security condition={at-risk, vulnerable, safe}

The monitoring frequency can be preconfigured to a default value or dynamically adjusted based on ay set of criteria.

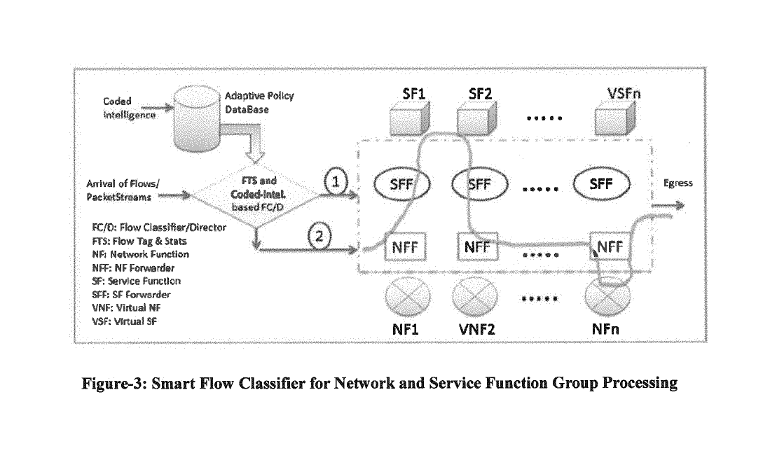

FIG. 3 shows smart flow classifier for network and service function group processing. As mentioned before, a flow can be routed to an SF through an NFF in addition to being routed directly from an SFF. The SFF can process the incoming flows in a round-robin fashion or on a fir-come-first-serve basis or using any other intelligent incoming flow processing mechanism. The stats tag of the flows can be utilized for intelligent servicing of the flows in the service function (SFs) which can be physical or virtual or a combination of both.

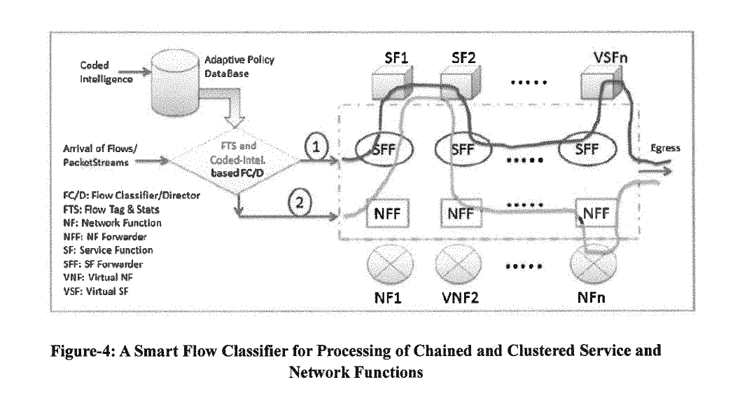

FIG. 4 shows smart flow classifier for processing of chained and clustered service and network functions. As discussed before, this diagram shows a mode of operation where SFFs are receiving flows from the egress of the classifier for chaining to the SFs through both SFFs and NFFs. Here again, the SFs can process the incoming flows in a round-robin fashion or on a fir-come-first-serve basis or using any other intelligent incoming flow processing mechanism. The stats tag of the flows can be utilized for intelligent servicing of the flows in the service function (SFs) which can be physical or virtual or a combination of both.

Although the invention has been described and illustrated in exemplary forms with a certain degree of particularity, it is noted that the description and illustrations have been made by way of example only. Specific terms are used in this application in a generic and descriptive sense only and not for purposes of limitation. Numerous changes in the details of construction and combination and arrangement of parts and steps may be made. Accordingly, such changes are intended to be included in the invention, the scope of which is defined by the claims.

What is claimed as new and desired to be protected by Letters Patent of the United States is:

1. A method of flow classification for network and service function chaining, the method comprising:
storing, in an adaptive policy database, conditions of a service function (SF), a network function (NF), a SF forwarder (SFF), and a NF forwarder (NFF), wherein the adaptive policy database provides an input to a classifier; and
inspecting, by the classifier, a tag or stat of an incoming flow and adjusting, by the classifier, the tag or stat of the incoming flow, based on the stored conditions, without impacting user or service experience.

2. The method of claim 1, further comprising updating the stored conditions in the adaptive policy database.

3. The method of claim 2, further comprising inspecting, by the classifier, a tag or stat of a second incoming flow and adjusting, by the classifier, the tag or stat of the second incoming flow, based on the updated stored conditions, without impacting user or service experience.

4. The method of claim 1, wherein one of the NF or the SF is at least partially virtual.

5. The method of claim 1, wherein the conditions comprise health, security, and loading conditions.

6. A system of flow classification for network and service function chaining comprising:
an adaptive policy database that stores conditions of a service function (SF), a network function (NF), a SF forwarder (SFF), and a NF forwarder (NFF);
a classifier that inspects a tag or stat of an incoming flow and adjusts, by the classifier, the tag or stat of the incoming flow, based on the stored conditions, without impacting user or service experience; and
wherein the adaptive policy database provides an input to the classifier.

7. The system of claim 6, wherein the stored conditions are updated in the adaptive policy database.

8. The system of claim 7, wherein the classifier inspects a tag or stat of a second incoming flow and adjusts the tag or stat of the second incoming flow, based on the updated stored conditions, without impacting user or service experience.

9. The system of claim 6, wherein one of the NF or the SF is at least partially virtual.

10. The system of claim 6, wherein the conditions comprise health, security, and loading conditions.
